(19) United States
(12) Patent Application Publication
(10) Pub. No.: US 2006/0147278 A1
(43) Pub. Date: Jul. 6, 2006

(54) Tilted loader/receiver

(76) Inventors: Doug Boring, Franklin, PA (US); Eric V. Pitchford, Pittsburgh, PA (US)

Correspondence Address: ReedSmith, 435 Sixth Avenue, Pittsburgh, PA, 15219-1886, US

(21) Appl. No.: 11/265,404

(22) Filed: Nov. 1, 2005

Related U.S. Application Data
(63) Continuation-in-part of application No. 29/216,758, filed on Nov. 8, 2004.
(60) Provisional application No. 60/624,503, filed on Nov. 1, 2004.

(51) Int. Cl. B65G 53/60

(52) U.S. Cl. 406/168

(57) ABSTRACT

A loader or receiver for use in conveying particulate material, typically plastic resin, which is positioned on a tilt from the vertical axis, on top of a material hopper, bin, or processing machine. The tilted angle of the loader or receiver allows for the maximization of payload capacity, a smooth flow of material discharge into the hopper, and easy access for cleaning, maintenance, and service.

This application claims priority from U.S. Provisional Application Ser. No. 60/624,503, filed Nov. 1, 2004. This application is a continuation-in-part application from U.S. Design application Ser. No. 29/216,758, filed Nov. 8, 2004.

### BACKGROUND OF THE INVENTION

1. Field of the Invention

The invention relates generally to vessels whose function is to receive particulate material, typically plastic resin, that is conveyed through conduits in a stream of gas, which is typically air. The vessel separates the particulate material from the stream of gas that conveys the material.

2. Description of the Background

Vessels whose function is to receive particulate material by separating resin particulate from the gas stream which conveys the particulate, and which then convey particulate to an attached hopper, are known in the prior art. The gas stream is typically generated either by an external vacuum pump or pressure pump (wherein this type of vessel is known as a vacuum receiver, hereinafter “receiver”) or by a power source associated with the particular vessel (wherein this type of vessel is known as an integral self loader, hereinafter “loader”).

The loader or receiver commonly has a lid which covers the external loading end of the loader or receiver. A vacuum valve or vacuum motor is commonly connected to the outer portion of the lid. The upper end of the loader or receiver can have an inlet connected to a material storage container from which material is drawn by an integrated vacuum motor or a remote vacuum source and is then delivered to the loader or receiver.

The loader or receiver is often mounted to the top of an equally-sized, or more typically, larger, material hopper or bin. The bottom of the loader or receiver body commonly opens into the top of the hopper or bin, and the bottom of the hopper or bin is commonly open into the material feed portion of a molding machine, extruder, subsequent hopper, or material conveying line.

The vacuum source creates a vacuum that draws material from a storage location into the body of the loader or receiver via the inlet, and then down through the body of the loader or receiver into the hopper. A filter may commonly be provided in the body portion of the loader or receiver between the material inlet and the vacuum source, thus producing the desired material and gas separation.

Plastic molding machines and extruders, with hoppers attached to the top, are often tall structures. Consequently, it can be difficult to access the loader or receiver for the purpose of maintenance, cleaning, or changing the filter.

To service the loader or receiver, the loader or receiver lid and connected vacuum motor or vacuum valve must be detached from the top of the loader or receiver and repositioned to allow access to the filter and the inside of the loader or receiver. Frequently, the repositioning of the lid is not feasible resulting in the technician having to hold the lid while performing his maintenance duties. Because of the height and orientation of conventional loaders and receivers, the inside of the loader or receiver body may not be easily accessible for inspection and cleaning by a technician.

Also, material loaders and receivers are often placed in groups on top of a variety of single or multiple hopper devices, operating in close proximity to each other. Consequently, the loaders or receivers compete for utility space and often must compromise cable and hose routing in order to function.

To make a loader or receiver functional, it must be supplied with power, control, a vacuum or pressure line, and a material line. A compressed air line is also typically used. These cables and hoses, as well as other optional accessories, can create conflicts between the routing of utilities and the ability to access the loader or receiver.

Typically, vertical loaders and receivers do not optimize payload capacity. The conventional means of increasing the overall volume without compromising overall unit height would require flattening the cone-shaped top portion of the loader or receiver, which would result in inner walls that were less steep. This shallow-angled cone would result in poorer material discharge flow from the loader body to the hopper below.

Thus, a need exists for a receiver or loader that maximizes payload capacity, and provides for efficient material discharge flow, while at the same time is accessible for cleaning, maintenance, and service.

### SUMMARY OF THE INVENTION

The present invention preferably is a loader or receiver that is positioned at a tilted angle off of the vertical axis, on top of a hopper, bin, or processing machine. The tilted angle of the loader or receiver allows for easier access for cleaning, maintenance, and service, routing of utilities, and also allows the volume of the loader or receiver to be maximized.

The angled loader or receiver body may be made of any suitable material and preferably may be either a cylindrical-shaped or conical-shaped member. A bottom end of the angled loader or receiver body can be attached to a top end of a base member which has an attachment surface that is not horizontal. The top end of the angled loader or receiver body can be attached to a lid which allows access to the angled loader or receiver.

### BRIEF DESCRIPTION OF THE DRAWINGS

For the present invention to be clearly understood and readily practiced, it will be described in conjunction with the following figures, which figures are incorporated into and constitute a part of the specification, wherein:

FIG. 1 is a front view showing cylindrical-shaped loaders/receivers mounted on hoppers, revealing their tilted angles.

FIG. 2 is a front view showing conical-shaped loaders/receivers mounted on hoppers, revealing their tilted angles.

FIG. 3 is a front view of a cylindrical-shaped tilted loader/receiver.

FIG. 4 is a front view of a conical-shaped tilted loader/receiver.

FIG. 5 is a bottom view of a cylindrical-shaped tilted loader/receiver.

FIG. 6 is a bottom view of a conical-shaped tilted loader/receiver.

### DETAILED DESCRIPTION OF THE INVENTION

It is to be understood that the figures and descriptions of the present invention have been simplified to illustrate elements that are relevant for a clear understanding of the invention, while eliminating, for purposes of clarity, other elements that may be well known. The detailed description will be provided hereinbelow with reference to the attached drawings.

In order to simplify and reduce the time and effort needed to service the loader or receiver, it would be preferable to have a loader or receiver that can permit a technician to easily inspect and clean the entire interior of the vessel without compromising safety. Additionally, in order to optimize the space for utilities and routing to and from the loader or receiver, it would be preferable to have a loader or receiver that optimizes the usable space for attaching hoses and wires. Finally, in order to maximize payload capacity, it would be preferable to have a loader or receiver that held more material without compromising overall unit height. Those improvements are accomplished by the present invention through the tilting of the loader or receiver. The present tilted design promotes access to the interior of the loader or receiver, increases space for utility connections and routing, and increases overall payload capacity.

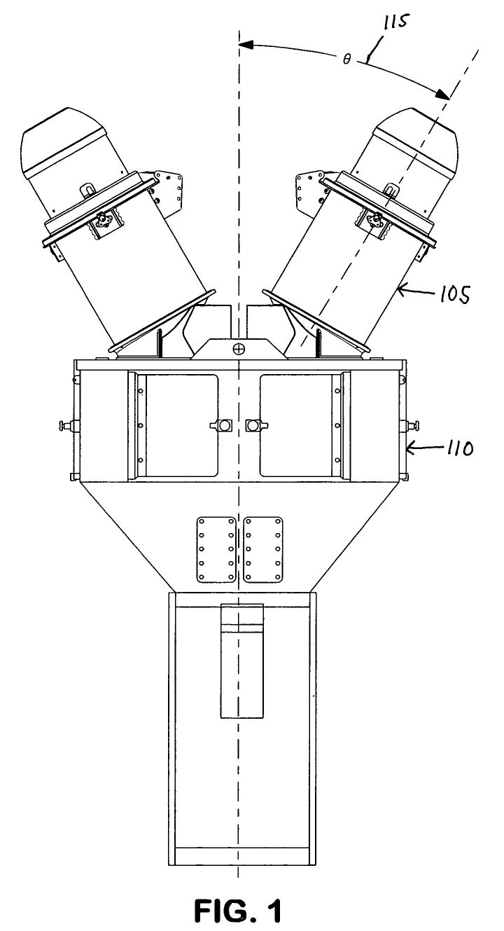

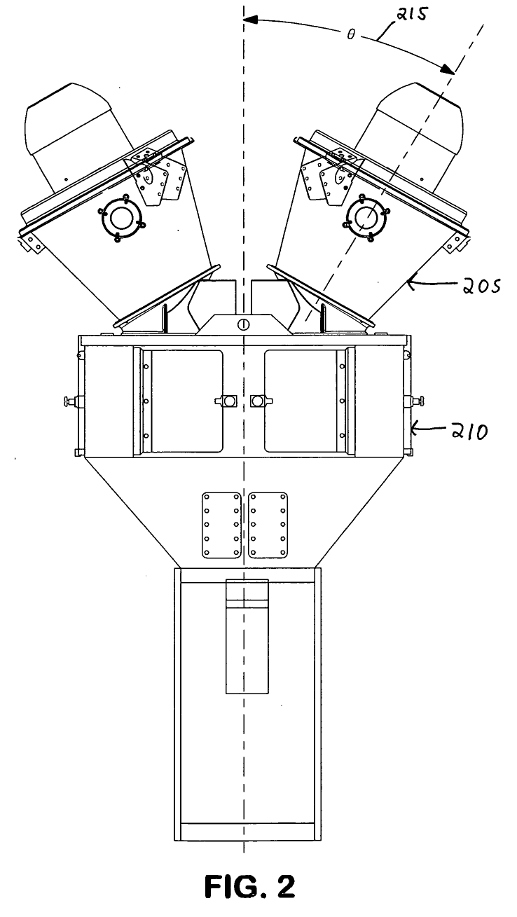

The tilted loader or receiver body of the present invention is positioned above a hopper, as illustrated in FIG. 1 and FIG. 2. A cylindrical loader or receiver body 105 is shown on top of a hopper 110, as illustrated in FIG. 1. The tilt 115 from the vertical axis is shown. FIG. 2 shows a conical loader or receiver body 205 on top of a hopper 210 with a tilt 215 from the vertical axis.

The tilted loader or receiver body may be made of any suitable material, most typically metal. In a presently-preferred embodiment, the tilted loader or receiver body is tilted down from the vertical axis at an angle of approximately 30 degrees. Additional embodiments of the present invention encompass tilted loader/receiver bodies that tilt between about 1 and about 45 degrees from vertical.

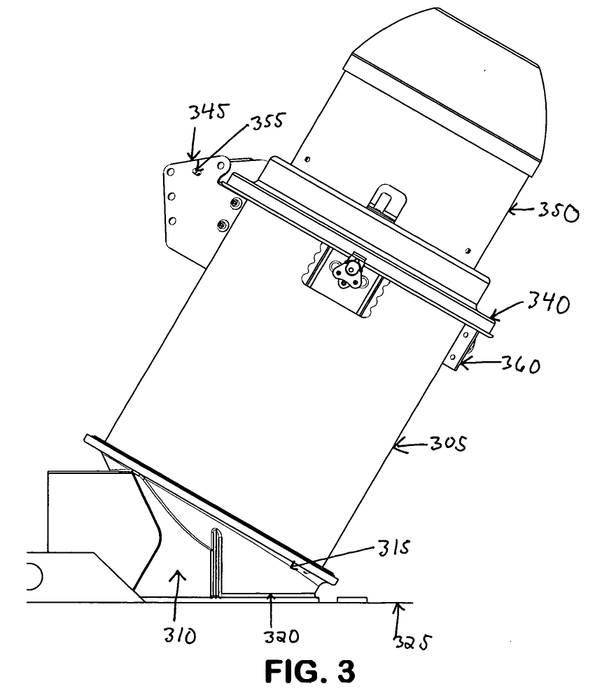

An illustration of the various parts of a cylindrical loader or receiver appears in FIG. 3. The angle of the tilt is achieved by attaching a bottom end of the tilted loader or receiver body 305 to a top end of a base member 310 via a first attachment surface 315 that is not horizontal. The base member 310 has a second attachment surface 320 which is horizontal, which in turn attaches to the horizontal mounting surface 325 of the hopper or bin (not shown) below.

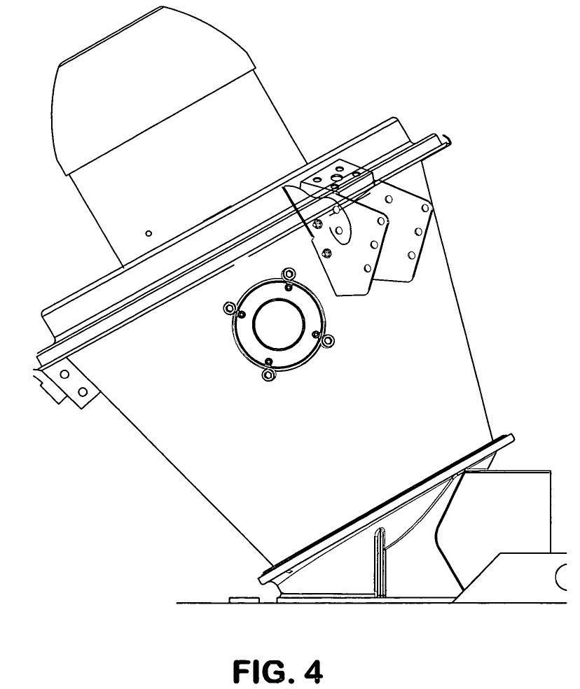

FIG. 4 shows a conical loader or receiver which has all the components of the cylindrical loader or receiver discussed above with reference to FIG. 3.

Further additional embodiments of the present invention contemplate tilted loader/receiver bodies that have an adjustable tilt. The adjustment of the tilt may be achieved by any of a number of methods. One such method involves inserting a pin through a hole located on the bottom end of the tilted loader or receiver body and then inserting the pin into one of a multitude of holes located on the attachment surface on the top end of the base member. Many other methods for adjustment of the tilt are also contemplated.

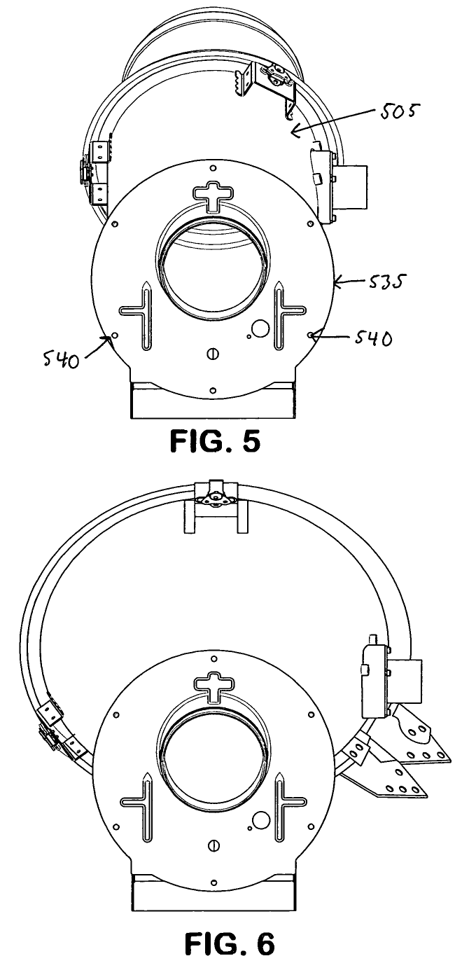

As shown in FIG. 5, the tilted loader or receiver body 505 preferably has a flange at the top and the bottom. The bottom flange 535 preferably includes a plurality of holes 540. The plurality of holes 540 in the bottom flange 535 mate with a second plurality of holes in the angled top of the base member (not shown). Machine bolts (not shown) are threaded through the plurality of holes 540 in the bottom flange 535 of the tilted loader or receiver body 505 and into the second plurality of holes in the top of the base member to secure the tilted loader or receiver body 505 to the base member. The plurality of holes 540 in the bottom flange 535 of the tilted loader or receiver body allow the tilted loader or receiver body 505 to be oriented in any one of six rotated positions. Additionally, a gasket (not shown) can be inserted between the base member and the tilted loader or receiver body 505 to seal the interface of these two parts.

FIG. 6 shows a bottom view of a conical loader or receiver which has all the components of the cylindrical loader or receiver discussed above in reference to FIG. 5.

Referring once again to FIG. 3, the top flange 340 of the tilted loader or receiver body 305 may have a plurality of brackets 345 welded to it, spaced around the body of the tilted loader or receiver 305. A lid 350 may be attached to one of the plurality of brackets 345 with a hinge 355, and the other brackets 345 may contain latches 360. Together, the hinge 355 and latches 360 fasten the lid 350 to the top portion of the body of the loader or receiver 305.

FIG. 4 shows a conical loader or receiver which has all the components of the cylindrical loader or receiver discussed above with reference to FIG. 3.

Nothing in the above description is meant to limit the present invention to any specific materials, geometry, or orientation of elements. Many part/orientation substitutions are contemplated within the scope of the present invention and will be apparent to those skilled in the art. The embodiments described herein were presented by way of example only and should not be used to limit the scope of the invention.

Although the invention has been described in terms of particular embodiments in an application, one of ordinary skill in the art, in light of the teachings herein, can generate additional embodiments and modifications without departing from the spirit of, or exceeding the scope of, the claimed invention. Accordingly, it is understood that the drawings and the descriptions herein are proffered only to facilitate comprehension of the invention and should not be construed to limit the scope thereof.

What is claimed:

1. A loader for use in conveying particulate material wherein said loader is positioned on a tilt from a vertical axis.

2. The loader of claim 1 wherein said loader is metal.

3. The loader of claim 1 wherein said loader is cylindrical.

4. The loader of claim 1 wherein said loader is conical.

5. The loader of claim 1 wherein said tilt is in the range of about 1 to 45 degrees from said vertical axis.

6. The loader of claim 1 wherein said tilt is about 30 degrees from said vertical axis.

7. The loader of claim 1 wherein a top end of said loader is operably connected to a plurality of brackets, said plurality of brackets being attached to a hinge with a lid and one or more latches.

8. The loader of claim 1 wherein a bottom end of said loader is operably connected to a top end of a base member, said top end of said base member having a first attachment surface that is not horizontal.

9. The loader of claim 8 wherein said base member has a second attachment surface which is horizontal, wherein said horizontal second attachment surface is adapted to be attached to a top mounting surface of a hopper.

10. The loader of claim 8 wherein said base member has a second attachment surface which is horizontal, wherein said horizontal second attachment surface is adapted to be attached to a top mounting surface of a bin.

11. The loader of claim 8 wherein said base member has a second attachment surface which is horizontal, wherein said horizontal second attachment surface is adapted to be attached to a top mounting surface of a processing machine.

12. The loader of claim 8 wherein said loader includes a flange on said bottom end of said loader, said bottom flange being operably connected to said top end of said base member via machine bolts threaded through a first plurality of holes in said bottom flange and further threaded into a second plurality of holes in said top end of said base member.

13. The loader of claim 12 wherein said first plurality of holes in said bottom flange allow said loader to be oriented in various positions.

14. The loader of claim 12 further comprising a top flange on a top end of said loader, wherein said top flange is operably connected to a plurality of brackets, wherein one or more of said plurality of brackets is further operably connected to a lid.

15. A receiver for use in conveying particulate material wherein said receiver is positioned on a tilt from a vertical axis.

16. The receiver of claim 15 wherein said receiver is metal.

17. The receiver of claim 15 wherein said receiver is cylindrical.

18. The receiver of claim 15 wherein said receiver is conical.

19. The receiver of claim 15 wherein said tilt is in the range of about 1 to 45 degrees from said vertical axis.

20. The receiver of claim 15 wherein said tilt is about 30 degrees from said vertical axis.

21. The receiver of claim 15 wherein a top end of said receiver is operably connected to a plurality of brackets, said plurality of brackets being attached to a hinge with a lid and one or more latches.

22. The receiver of claim 15 wherein a bottom end of said receiver is operably connected to a top end of a base member, said top end of said base member having a first attachment surface that is not horizontal.

23. The receiver of claim 22 wherein said base member has a second attachment surface which is horizontal, wherein said horizontal second attachment surface is adapted to be attached to a top mounting surface of a hopper.

24. The receiver of claim 22 wherein said base member has a second attachment surface which is horizontal, wherein said horizontal second attachment surface is adapted to be attached to a top mounting surface of a bin.

25. The receiver of claim 22 wherein said base member has a second attachment surface which is horizontal, wherein said horizontal second attachment surface is adapted to be attached to a top mounting surface of a processing machine.

26. The receiver of claim 22 wherein said receiver includes a flange on said bottom end of said receiver, said bottom flange being operably attached to said top end of said base member via machine bolts threaded through a first plurality of holes in said bottom flange and further threaded into a second plurality of holes in said top end of said base member.

27. The receiver of claim 26 wherein said first plurality of holes in said bottom flange allow said receiver to be oriented in various positions.

28. The receiver of claim 26 further comprising a top flange on a top end of said receiver, wherein said top flange is operably connected to a plurality of brackets, wherein one or more of said plurality of brackets is further operably connected to a lid.
